(19) United States
(12) Patent Application Publication
(10) Pub. No.: US 2011/0005055 A1
(43) Pub. Date: Jan. 13, 2011

(54) METHOD FOR ASSEMBLING A PART ON A PIVOT ORGAN

(75) Inventors: Christophe GIGANDET, Le Locle (CH); Armin BEHREND, Les Verrieres (CH); Francisco DIAS, Fleurier (CH)

Correspondence Address: YOUNG & THOMPSON, 209 Madison Street, Suite 500, Alexandria, VA, 22314, US

(73) Assignee: CHOPARD TECHNOLOGIES SA, Fleurier (CH)

(21) Appl. No.: 12/832,294

(22) Filed: Jul. 8, 2010

(30) Foreign Application Priority Data
Jul. 10, 2009 (EP) 09165254.5

(51) Int. Cl. B23P 11/00

(52) U.S. Cl. 29/428

(57) ABSTRACT

A method for assembling a hard part made of a material the hardness of which is higher than 500 Vickers, a pivot organ, includes: having a pivot organ including a tubular portion and a bearing surface extending around the tubular portion; introducing the hard part freely on the pivot organ around the tubular portion, the hard part having at least one structure built in advance, defining an entry and pulling the hard part in contact with a malleable organ also set on the pivot organ around the tubular portion, so that it is positioned over the entry of the structure, this assembly being formed by the hard part and the malleable organ being brought to bear the support surface; deform irreversibly the malleable organ to create catches formed by the washer and housed inside the structure without any degree of freedom, the malleable organ made integral with the pivot organ.

### TECHNICAL FIELD

This invention relates to a method for assembling a hard part on a pivot organ. By pivot organ, it is meant an axis or canon for receiving an axis.

### STATE OF THE ART

In recent years, the materials used in watchmaking have evolved considerably. Particularly, the growth and etching techniques developed for other branches of microtechnology offer particular opportunities for applications in watchmaking. However, most of these new materials such as silicon or diamond have no plastic field or have a small plastic field, that is to say they cannot undergo plastic deformation. The driving methods used commonly to install a part, such as a wheel on an axis cannot be used because they cause the part to break.

To overcome this drawback, solutions consisting of installing, at the part's hub, an elastic structure to enable its assembly on an axis have been proposed. Such a structure needs to provide for additional organs, to eliminate the degrees of freedom of the part in relation to the axis, both angularly and longitudinally.

Document EP1850193 proposes a method for driving a first part in a second part without plastic deformation, consisting in introducing a first hole of the second part a comprising a deformable mid part comprising a second hole, and driving the first part into the second hole so as to tighten the mid part against the wall of the first hole by deformation of the mid part. While it is interesting to apply pressures relating to driving on a mid part, and not on a part without plastic deformation, the latter is nevertheless subject to the impact of these pressures. In addition, attaching the part on an axis during rotation cannot be satisfactory when a high torque needs to be applied, unless a substantial radial stress is applied on the part without plastic deformation when driving the intermediate part, which does not solve the original problem related to the fragility of the part without plastic deformation. More generally, such difficulties can be encountered with hard parts, manufactured of materials typically having hardness higher than 500 Vickers. Besides silicon and diamond, nickel, steel, ceramics and stones (natural and artificial), are also materials used in watchmaking that could result in this kind of problem.

The purpose of this invention is to provide a method for assembling a hard part on an axis or, more generally, on a pivot organ, free of the above mentioned drawbacks.

### DISCLOSURE OF THE INVENTION

More specifically, the invention relates to a method for assembling a hard part on a pivot organ, comprising the following steps:
i. being equipped of a pivot organ comprising a tubular portion and a bearing surface extending around the tubular portion,
ii. introducing the hard part freely on the pivot organ around the tubular portion, said hard part having at least one housing defining an entry and pulling said hard part into contact with a malleable organ also arranged on the pivot organ around the tubular portion, so that it is positioned over the entry of the housing, the assembly being formed by the hard part and the malleable organ being brought to bear the support surface,
iii. irreversibly deforming the malleable organ so as to create catches formed by the washer and housed inside the housing without any degree of freedom.
   The malleable organ would have been attached to the pivot organ during the assembly process or in advance.

Other specific steps of the method according to the invention are mentioned in the claims.

### BRIEF DESCRIPTION OF THE DRAWINGS

Other characteristics of the present invention will become more evident upon reading the following description, with reference to the accompanying drawings, wherein:

FIG. 1 shows the steps of a first implementation of the method according to the invention,

FIGS. 2, 3, 4 and 5 represent two other implementations of the method, and

FIGS. 6 and 7 provide various specific shapes of parts used in the implementation of the method according to the invention.

### EMBODIMENT(S) OF THE INVENTION

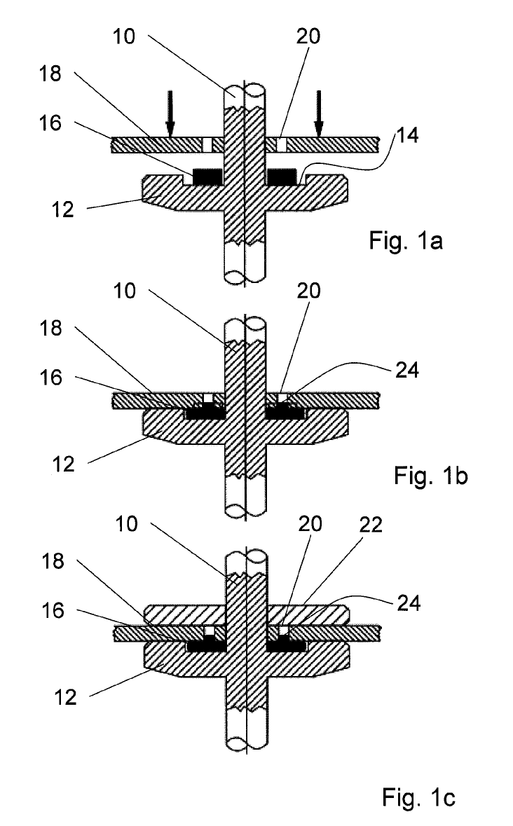

FIG. 1 shows the various organs of the embodiment of the method according to the invention. Thus, there is a pivot organ, this term encompassing various parts intended to be assembled onto a mobile to allow installation by rotation of the latter. As in FIG. 1, the pivot organ may be an axis 10 with a tubular portion and the ends of which, not shown, form the pivots.

The axis 10 comprises a cup 12 extending radially around the axis 10. The cup 12 defines a bearing surface. It may be disk shaped. According to a preferred embodiment, the cup is equipped, on one of its surfaces with an annular recess 14 located around the axis. The shape of the recess is indifferent. Especially for the method described in this example, the recess is located immediately at the base of the axis, with at least one open area on the axis.

A malleable organ, typically a plastic washer 16 generally in annular shape, is also used in the method according to the invention. This washer 16 may be metallic or synthetic and, possibly, display elastic properties. It is likely to be deformed by cold or hot creep, by the application of mechanical stress. A material in paste form, which may be deformed, then stiffened, for example by polymerisation, can also be used. A washer 16 made of gold, tin, aluminium, rubber, polymer, for example, may be implemented.

This washer 16 is sized to be seated in the recess 14. Thus, it has a central opening, intended to enable the introduction of the axis 10. Preferably, the central opening is circular with a diameter slightly larger than the outside diameter of the axis 10, allowing an unconstrained positioning of the washer 16. The shape of the outer contour of the washer 16 is indifferent; it must simply be adapted to the shape of the recess 14. In this example, the thickness of the washer 16 is higher than the depth of the recess 14 so that the washer 16 protrudes from the latter.

Finally, there is a hard part 18, without plastic field or with a low plastic field, made of materials typically having hardness higher than 500 Vickers. The hard part 18, in particular, may be made of silicon, diamond, nickel or steel. The hard part 18, for example, may be a wheel or a lever, intended to be assembled on the axis. To this end, the hard part 18 comprises a through-hole, the shape of which is adjusted to that of the axis 10 to be inserted freely on the axis. Depending on the positioning accuracy of the desired part, there can be some slight play or slight elasticity, but without applying radial stress on the hard part 18. The latter still has at least one housing 20 defining an entry, positioned so as to discharge next to the washer 16. According to the example, the hard part 18 is passed through by two tubular orifices, preferably cylindrical, acting as housings.

Optionally, a cover 22 may also be provided. It comprises an opening sized to allow driving on the axis 10. The dimensions of the cover 22 are typically similar to those of the cup 12 in order to hide the visible parts of the assembly resulting from the method and allowing also balancing the assembly. It will be observed that in case the washer 16 is made of an elastic material, the cover is particularly important for the axial positioning of the washer in relation to the pivot organ.

For the assembly thereof, the washer 16 is arranged in the recess 14. Then, the hard part 18 is mounted on the axis 10 and is pressed against the washer 16 which protrudes from the recess 14. Due to the fact that, as described above, the opening of the housings 20 is located next to the washer 16, the pressure exerted on the part 18 is sufficient to cause creep of the washer 16 inside the housings 20. This deformation induces the creation of catches 24, washer parts 16 thus deformed, inserted without any degree of freedom in the housings 20 of the part 18. The part 18 and washer 16 are therefore absolutely attached in rotation. In addition, the washer 16 is positioned near the axis 10 the pressure exerted on the washer 16 also induces, as shown in the figures, a deformation of the washer 16 toward the axis 10. The latter is found to be very tight by the washer 16. The hard part 18 is thus fixed onto the axis 10, without any degree of freedom. In addition, due to the presence of the catches 24, the force to be applied on the hard part 18 to disengage the latter from its axis, involves a component relating to the shear stress, necessary to break the catches 24. There are also shear forces exerted on the catches 24 during the rotation of the part, which allows a better distribution of the constraints linked to torque.

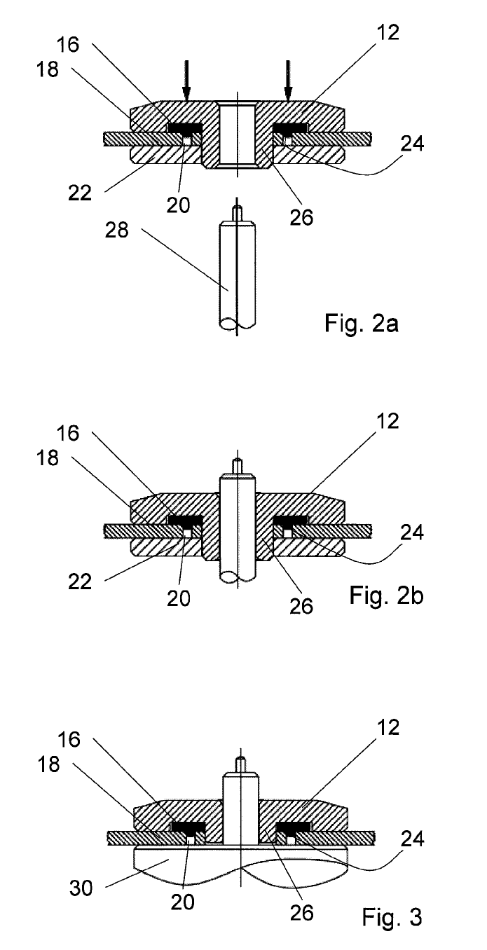

FIGS. 2a and 2b show another embodiment of the invention wherein the pivot organ is a canon 26 having a tubular portion and intended for receiving an axis 28. The canon 26 has a cup 12, similar to what has been described above with reference to FIG. 1, provided with a recess 14 for receiving a washer 16. A hard part 18 is assembled freely in the canon 26, similarly to what has been described with reference to FIG. 1. In FIGS. 2a and 2b, a cover 22 is used to hide visible parts of the assembly resulting from the method. Advantageously, an independent and functional assembly is produced, including the canon 26, the washer 16 and the hard part 18, and possibly the cover 22. The axis 28 may then be mounted inside the canon 26 but, as understood, it is not driving the axis that allows holding the above mentioned assembly.

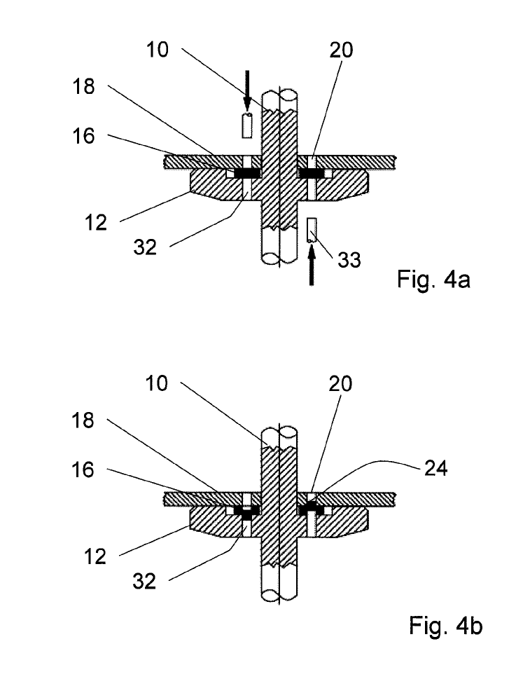

FIG. 3 also shows an implementation of the invention with a canon 26. In this example, there is no cover and the axis has a direct mobile 30, acting as a cover. It will be observed that, advantageously, the mobile is a wheel or a toothed pinion. The canon 26 does not protrude beyond the hard part 18, so that after assembly of the axis 28 and the mobile 30, the latter is pressed against the hard part 18 without a gap between the two organs.

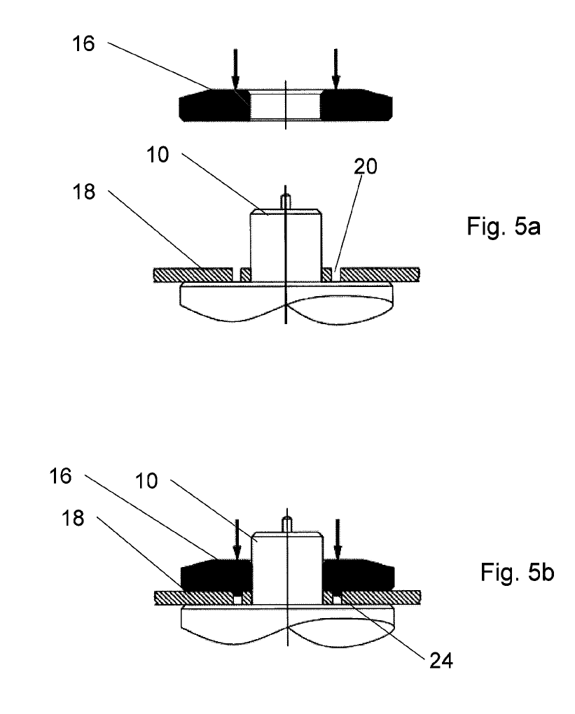

FIGS. 4a and 4b represent a further implementation of the method according to the invention. Especially in this embodiment, it is worth noting that the washer 16 does not need to protrude from the recess 14. The thickness of the washer 16 is preferably equal or close to the depth of the recess. At least some of the housings 20 of the hard part 18 are through-holes. In addition, the cup 12 is provided with cavities 32, some of which are at least through-holes, discharging next to the washer 16. The housings 20 of the hard part 18 and the cavities 32 of the cup 12 are positioned so as to be opposite two by two.

Thus, the washer 16 first, is set in the recess 14, and then the hard part 18 is set on top, so that the housings 20 of the hard part 18 to 32 and of the cavities of the cup 12 are opposite two by two. A skilled person may provide indexing means for easily guiding the two organs one with reference to the other. Then, by holding the pieces in position, a suitable tool 33 is passed through the cavities 32 and the through-hole housings 20 of the cup 12 and, respectively, of the hard part 18, which are therefore accessible, and pressure is exerted on the washer 16. The latter will creep into the housings 20 of the hard part 18 and, respectively, into the cavities 32 of the cup 12 to form catches 24.

The hard part 18 and the cup 12 of the pivot organ are thus perfectly attached, without any degree of freedom between the two. It will be observed that in this case, it is not necessary for the recess 14 to be located immediately at the base of the tubular portion of the pivot organ. The washer 16 may be of any shape. Indeed, the catches 24 created inside the cup provide directly the attachment of the washer to the pivot organ.

A skilled person can still consider other alternatives. For example, the deformation of the washer 16 may be carried out thermally, by melting for example of the washer, during which as a result of the applied pressure, the material of the washer 16 simply flows into the housings 20 of the hard part 18 and, where appropriate, into those of the cup 12.

It is also possible for the washer 16 to be fixed to the cup 12 in a step independent of the deformation step of the washer 16. For example, and depending on the material chosen for its implementation, the washer 16 may be glued, welded, brazed, even deposited directly by galvanising it onto the cup. In such cases, it is not necessary to set the washer 16 so that it attaches on the tubular portion of the pivot organ during the deformation step of the washer, as mentioned above.

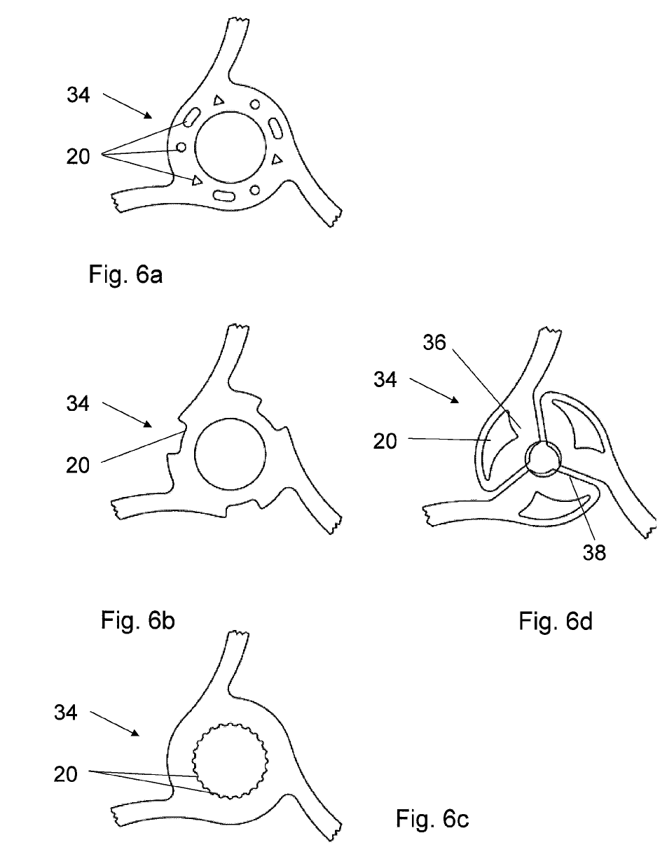

FIGS. 5a and 5b show a further embodiment of the method according to the invention, wherein the hard part 18 is freely installed on the tubular portion of the axis 10. Particular to this embodiment, the washer 16 is sized to be driven on the axis 10. In particular, its thickness is sufficient to withstand the mechanical stresses induced by such a driving, the thickness being a function of the strength of the material. During assembly of the washer 16 on the axis 10, the washer and the tubular portion are attached by driving. When the washer 16 comes into contact with the hard part 18, the washer is pressed against the hard part so as to creep the washer 16 in the housings that contain the hard part 18 and to create the catches 24.

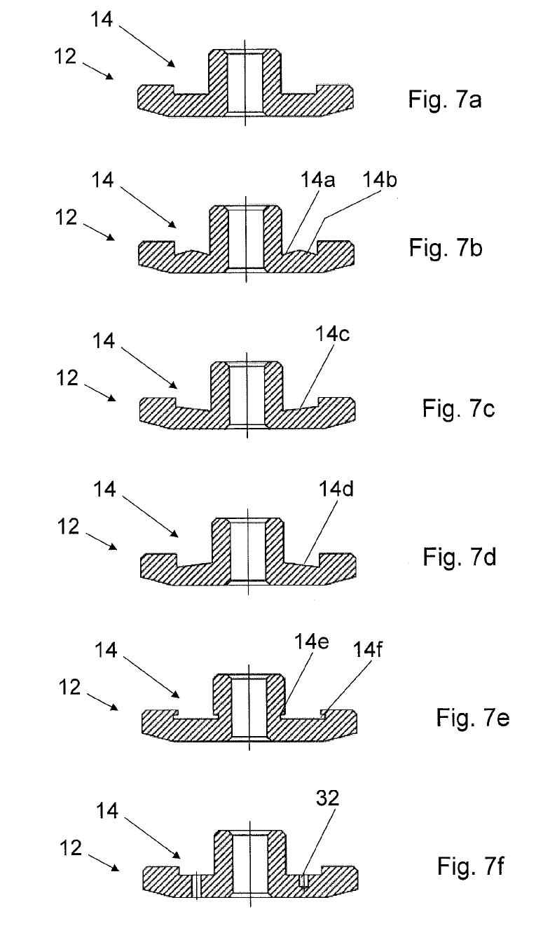

FIGS. 6a, 6b, 6c and 6d provide different examples of housings 20 achievable on a hard part, within which the catches may form 24 from the washer. In this case, the figures show a hub 34 of a mobile. Thus, the housings 20 may consist of openings, in any closed shape, performed on the hub 34. The housings may also be of open shape on the inner or outer circumference of the hub 34. The housings 20 are then notched, more or less deformed. The arrangement of the housings can be used, preferably, so that the centre of gravity of the mobile is aligned with the rotation axis. The housings are preferably spread on the area of the hard part 18 intended to be next to the washer 16. FIG. 6d shows a particular structure of the hub, with an open elastic structure to be assembled on the axis. Each radius of the wheel ends at the centre of the wheel in a gripping area 36, forming the hub of the wheel. The radially oriented slots 38, separate two consecutive gripping areas. The slots can ultimately discharge, on the centre side of the wheel in a notch similar to those of FIG. 6c. In addition, these gripping areas are also equipped with housings 20. While assembling such a wheel with a washer 16, the malleable material will creep into the slots and also into the openings of the gripping areas.

More generally, the housings 20, arranged in a spotted manner at the surface of the hard part, may be replaced by microstructures formed at the surface of the hard part in areas to be in contact with the malleable organ. The term “spotted” means a surface or a space limited around a definite point, such as proposed by the tubular housings. These structures can be regular or irregular, produced by sanding or sunbursting techniques. As it deforms, the malleable organ penetrates into the interior of the structures formed at the surface of the hard part and thus provides a multitude of small catches.

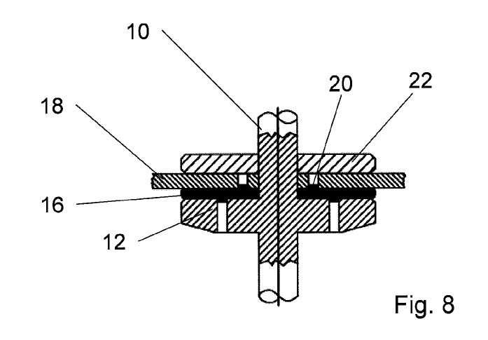

FIGS. 7a to 7f show different patterns used to achieve the recess 14 in order to guide the direction in which the material constituting the washer is going to creep. The example in FIG. 7a is the simplest, with a recess the bottom of which is flat. In FIG. 7b, the bottom of the recess is rib shaped, defining a first inside flank 14a leaning toward the centre of the washer, and a second outer flank 14b leaning toward the outside of the washer. FIGS. 7c and 7d provide a base with a single flank, leaning respectively 14c towards the centre 14d and outside of the washer. In FIG. 7e, the bottom of the recess is flat, but an inner groove 14e, and an outer groove 14f are defined by the edges of the bottom of the recess. In other words, the recess is wider at its bottom. FIG. 7f shows how the through-holes or the blind cavities 32 may be fitted in the bottom of the recess. The bottom of the recess can also be structured along the lines of what is proposed above for the hard part. This strengthens the interaction between the malleable organ and the pivot organ.

Thus a method is provided for assembling a hard part on a pivot organ, particularly simple to implement. In addition, it is worth noting that the hard part is not subjected to radial stress. It is only affected by the compression applied during the deformation of the washer and this kind of pressure is particularly well supported by parts in silicon, diamond etc.

A skilled person will still consider other embodiments, within the general framework of the invention, defined by the claims. For example, it is possible to have a washer on the plastic cup, without recess, when the dimensions of the washer, for thickness and surface in contact with the support surface, are adapted. Such a solution is shown in FIG. 8. Similarly, the recess may not be annular. The support surface may have a plurality of recesses distributed around the tubular portion. Malleable organs are arranged in recesses to cooperate with the housings positioned accordingly in the hard part. It will be observed that the malleable organs may be of any shape. Indexing means may be provided to position the malleable organs and the housings next to each other.

1. A method for assembling a hard part made of a material the hardness of which is higher than 500 Vickers, a pivot organ, comprising the following steps:
i. having a pivot organ comprising a tubular portion and a bearing surface extending around the tubular portion,
ii. introducing the hard part freely on the pivot organ around the tubular portion, said hard part having at least one structure built in advance, defining an entry and pulling said hard part in contact with a malleable organ also set on the pivot organ around the tubular portion, so that it is positioned over the entry of the structure, this assembly being formed by the hard part and the malleable organ being brought to bear the support surface,
iii. deforming irreversibly the malleable organ so as to create catches formed by said malleable organ and housed inside the structure without any degree of freedom,
the malleable organ having been made integral with the pivot organ.

2. The Method of assembly of claim 1, wherein said bearing surface has a recess around the pivot organ, wherein the malleable organ is a washer, said washer being placed in the recess.

3. The method of claim 1, wherein the attachment of the malleable organ and the pivot organ is carried out at the same time as step iii of deformation of the malleable organ.

4. The method of claim 2, wherein the attachment of the malleable organ and the pivot organ is carried out at the same time as step iii of deformation of the malleable organ.

5. The method of claim 2, wherein the thickness of the washer is higher than the depth of the recess, so as to protrude from said recess.

6. The method of claim 3, wherein the thickness of the washer is higher than the depth of the recess, so as to protrude from said recess.

7. The method of claim 4, wherein the thickness of the washer is higher than the depth of the recess, so as to protrude from said recess.

8. The method of claim 5, wherein said recess is formed at the base of the pivot organ.

9. The method of claim 6, wherein said recess is formed at the base of the pivot organ.

10. The method of claim 7, wherein said recess is formed at the base of the pivot organ.

11. The method of claim 1, wherein the step for fixing the malleable organ is performed subsequent to the step of placing the said malleable organ, before introducing the hard part.

12. The method of claim 1, wherein the malleable organ is placed on the bearing surface being directly carried out by galvanic growth.

13. The method according to claim 1, wherein the deformation of the malleable organ is performed mechanically.

14. The method according to claim 1, wherein the deformation of the malleable organ is performed thermally.

15. The method according to claim 1, wherein the pivot organ is an axis (10).

16. The method according to claim 1, wherein the pivot organ is a canon (26) intended to receive an axis.

17. The method according to claim 1, wherein it involves a further step subsequent to step iii consisting in adding a cover (22) on the pivot organ, over the hard part (18), the latter being intercalated between the bearing surface and the cover, so as to conceal the visible organs resulting from operations i. to iii.

18. The method according to claim 1, wherein the recess (14) is shaped so as to guide the deformation of the washer.

19. The method according to claim 1, wherein it involves a step of micro-structuring the hard part, so as to provide a microstructure on the surface of the hard part, in areas intended to be in contact with malleable organ.

20. The method according to claim 1, wherein it involves a step for producing said structure in the shape of at least one spotted housing.

21. The method of claim 20, wherein the hard part has a hub, wherein the at least one housing is a notch arranged on the inner or outer circumference of the hub.

22. The method according to claim 1, wherein the hard part has at least two housings of which at least one is a through-hole and in which the bearing surface is made by a cup equipped with at least two cavities, of which at least one is a through-hole and the opening of which is positioned so as to discharge next to the malleable organ; the housings of the hard part and the cavities of the cup being arranged so as to be able to be positioned opposite two by two,
wherein
step ii. is performed by placing the malleable organ and the hard part on the pivot organ, so that the housings of the hard part and cavities of the cup are opposite two by two,
step iii. consists in deforming the malleable organ by running a tool adapted by the through-in openings of the cup and the hard part, and exerting pressure on the malleable organ while maintaining the parts in position so as to drop malleable organ into the housings of the hard part and, respectively, in the cavities of the cup and thereby creating said catches.
